(19) United States
(12) Patent Application Publication
(10) Pub. No.: US 2002/0103906 A1
(43) Pub. Date: Aug. 1, 2002

(54) Internet protocol intranet network system and method for a financial institution

(76) Inventors: Thomas A. Knight, Kansas City, MO (US); Shelly S. Biddlecombe, St. Peters, MO (US); Stacy L. Braden, Liberty, MO (US); Rick Devault, Independence, MO (US); Kevin O. Dillon, Olathe, KS (US); Katherine S. Wright, Grain Valley, MO (US); Joel E. Verwers, Kansas City, MO (US); David Young, Independence, MO (US); Kevin Lieurance, Blue Springs, MO (US); Bruce Molay, Cambridge, MA (US); Chad Nelson, Lee's Summit, MO (US); Rosalind E. Phillips, Kansas City, MO (US); Paul Rasmussen, Kansas City, MO (US); John Selzer, Shawnee Mission, KS (US); Joe E. Vasquez, Olathe, KS (US); Trenton D. Madden, Independence, MO (US); Catherine L. Chilton, Crestwood, MO (US); Michelle Y. Ahrens, St. Louis, MO (US); Margaret M. Shaft, Kansas city, MO (US)

Correspondence Address: BLACKWELL SANDERS PEPER MARTIN LLP, 720 OLIVE STREET, SUITE 2400, ST. LOUIS, MO, 63101, US

(21) Appl. No.: 09/901,418

(22) Filed: Jul. 9, 2001

Related U.S. Application Data
(60) Provisional application No. 60/217,882, filed on Jul. 10, 2000.

(51) Int. Cl. G06F 15/16; G06F 15/173

(52) U.S. Cl. 709/225; 709/218

(57) ABSTRACT

An web browser-based system and method providing an intranet environment communicably linked to a system containing legacy applications. The web browser-based system comprises a plurality of remotely located client personal computers that are equipped with web browser applications that are communicably linked to centralized web server farms and data servers which are equipped to communicate with a mainframe system having a plurality of legacy applications. The system is specifically adapted to service a plurality of branches of a commercial Financial Institution, specifically a bank. The system provides the ability to service a customer at a client personal computer equipped with a web browser application.

### CROSS REFERENCES

This application claims the benefit of U.S. Provisional Application No. 60/217,882, filed Jul. 10, 2000.

### BACKGROUND OF INVENTION

(1) Field of Invention

This invention is related to computer networks and particularly to a worldwide web browser based intranet network.

(2) Background Art

Financial Institutions and, more particularly, banking institutions are heavily dependent on their computing systems to provide quality services to their customers in a timely manner. One traditional computing method and system utilized by Financial Institutions such as bank is a centralized mainframe based system. Such a system includes a centralized mainframe computer that is communicably linked to a plurality of dumb terminals that are remotely located from the mainframe system at various branch office locations or remote service. The client or the user calls up various mainframe applications designed to service requests from the client initiated at the dumb terminal. Various Legacy Systems reside on the mainframe that are designed to process requests to open new accounts, such as demand deposit accounts, CD's, IRA's and plastic products. There are also various legacy data sources that reside on the mainframe system which include customer and account information. This type of mainframe system typically has a slow response time and when a computer crash occurs not even minimal computing ability is maintained at the dumb terminal. Also, this type of mainframe system typically has an intensively code driven and command driven user interface where the user is required to memorize the commands for various functions. Therefore, training must be provided.

An alternative computing system that has been traditionally utilized in the commercial financial industry, particularly the banking industry, comprises a mainframe communicably linked to various remote smart desktop computers or remote mini computers or servers. This type of computing system allows for certain applications to reside locally on the computers at the remote sites, as opposed to relying on a centralized mainframe system. Also, this type of computing system can allow for downloads of large portions of data such that the mainframe system is not continuously queried for data. This type of system typically responds to client requests more efficiently, however, this type of system requires that each remote desktop computer or server be updated each time applications are revised. Another shortcoming of this type of system is that typically there is not real time access to the data as it is updated at each remote site. There is typically some delay for the updated data to be uploaded back to the mainframe and available to other users. Many times there are only once per day or twice per day uploads to the mainframe from the remote sites. Work flow can be hindered when little or no data is available real time time.

### BRIEF SUMMARY OF INVENTION

The invention is a web browser-based intranet network system and method that serves as a centralized system for use by a commercial financial entity having a plurality of branch locations or remote service sites. The invention comprises a centralized sales and service computing tool which is adapted to service a client computer at the service site or branch office and to store and maintain the data necessary to enable each branch or service site in electronic communication therewith to provide various services to its customers, access real time time data changes and updates, and coordinate operations with other branches of the commercial entity. In one embodiment of the invention, the web browser-based network platform includes at least one centralized server farm communicably linked to a plurality of branch office computers (clients) by a Wide Area Network (WAN) providing for high speed communications over the internal network or intranet. High speed communication servers which form the backbone of the sales and service tool provided over the internal network or intranet make up a centralized web server farm, which is operable to provide a plurality of dynamically built Hyper-Text Markup Language (HTML) document, using Active Server Pages (ASP) and delivered in Hyper-Text Transfer Protocol (HTTP) protocol to the plurality of clients by way of the Transmission Control Protocol/Internet Protocol (TCP/IP) communications link, and said at least one centralized web server farm is operable to be communicably linked to a plurality data servers and at least one mainframe system. The mainframe system of the Financial Institution with its existing Legacy Systems need not be modified. The present invention is designed to communicate with existing Legacy Systems and the unmodified Legacy Systems provide information as originally designed. The mainframe is operable to provide customer, product, administrative and account information to the web server farm, as well as specific applications for servicing the various requests from the plurality of branch offices or remote service sites or other banking channels such as ATM's, Internet, and call centers. The mainframe is also the main processing means for various applications such as ATM and teller applications. The various data servers that are remotely located and communicably linked to the web server farm can be operable to perform various data manipulations to support service.

One embodiment of the invention comprises a client personal computer equipped with a standard web browser; a web server operable to generate active web server pages, as well as provide a communication gateway to a centralized web data server farm and mainframe system; where the web data server farm comprises at least one SQL server for application data and at least one server for a data warehouse where communication to these data servers are facilitated by stored procedures residing on the data servers or dynamically built SQL statements; and where the servers are operable to communicate with the mainframe system which comprises various Legacy Systems. The present invention allows functionality of the mainframe to defer much of the data storage, functionality and applications to a centralized server farm and centralized data servers such that the mainframe is not queried as often as dumb terminal systems, thereby increasing efficiency. However, unlike many smart terminal systems, the present invention with the centralized servers provides more real time time data updates that are available to all client computers equipped with a browser and on the network. Also, unlike many smart terminal systems, when application updates are required, the present invention does not require updating each computer at the various remote sites. The present invention, however, is still able to leverage on the computing capacity of the client computer while only maintaining a standard web browser environment. The present invention does not require a change to the existing mainframe.

These and other advantageous features of the present invention will be in part apparent and in part pointed out herein below.

### BRIEF DESCRIPTION OF THE DRAWING

For a better understanding of the present invention, reference may be made to the accompanying drawing in which:

FIG. 1 is a system block diagram of the web browser-based network coupled to the mainframe system;

FIG. 2 is a functional diagram of the Business corn Dynamic Link Library (DLL) and its interactions with other components of the network;

FIG. 3 is a functional diagram of the communication corn DLL and shared DB module and its interactions with other components of the network;

FIG. 4 is a functional diagram of the data servers and their interactions with other components of the network;

FIG. 5 is a functional diagram of the mainframe system and its interconnections with the web-based intranet system;

FIG. 6 is a flow diagram representative of a typical communication flow through the Business component DLL;

FIG. 7 is a flow diagram representative of a typical communication flow through the mainframe interface;

FIG. 8 is a flow diagram representative of a typical communication flow through the ASP function; and

FIG. 9 is a flow diagram representative of a typical communication flow through the mainframe Listener/Director function.

### DETAILED DESCRIPTION OF INVENTION

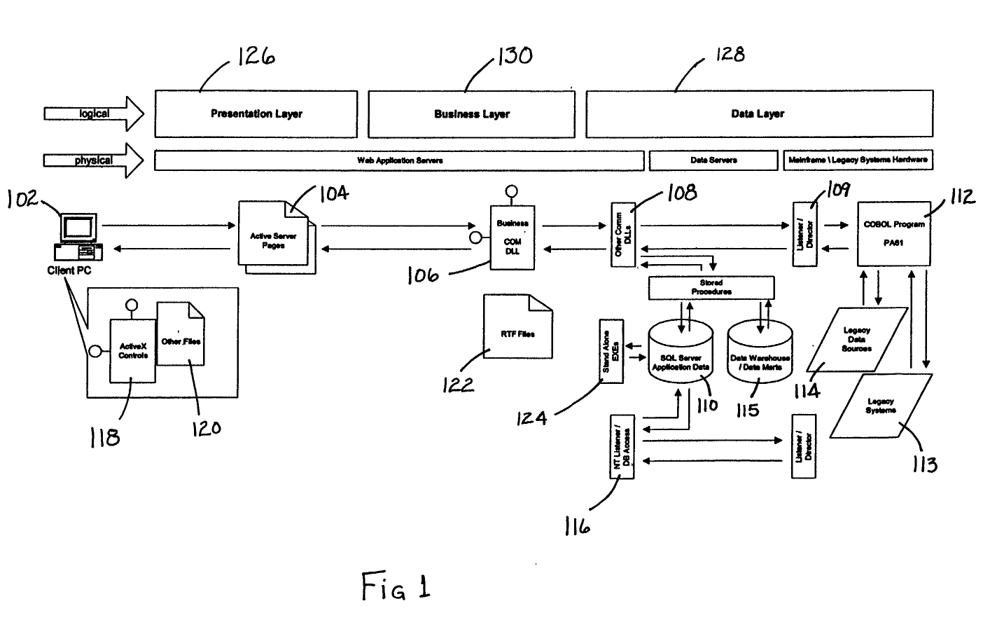

According to the embodiment(s) of the present invention, various functional diagrams are illustrated in FIGS. 1-9 and like reference numerals are being used consistently throughout to refer to like and corresponding parts of the invention for all of the various functional diagrams and figures of the drawing. Also, please note that the first digit(s) of the reference number for a given item or part of the invention should correspond to the FIG. number in which the item or part is first identified.

One embodiment of the present invention comprising a client personal computer communicably linked through an intranet network to centralized servers and at least one mainframe teaches a novel system and method for servicing customers of a Financial Institution by communicably linking various branch offices.

The details of the invention and various embodiments can be better understood by referring to the figures of the drawing. Referring to FIG. 1, a client personal computer 102 is shown located at a remote branch office with a browser application, preferably MICROSOFT INTERNET EXPLORER (IE) 4.0 or greater, and capable of TCP\IP communication to the web\application servers. Also shown are ASP 104 running on the web\application servers. Preferably, the servers run MICROSOFT WINDOWS NT 4.0 with INTERNET INFORMATION SERVER (IIS). Business components 106 containing the business logic are written as related business object DLL built using an object modeling technique that run on the web\application servers. Other communication components 108 are broken out to indicate the separation of data layer 128 logic from the business layer 130 logic. Separate communication components handle the data access and mainframe conversations. Also shown are the data servers, including application data server 110 which is a relational Database (DB) accessed by SQL. This data source serves as a data cache for legacy data gathered throughout a business day and a data store for session and new application information. This layer handles the management of the communication, deciphering the received transaction, and initializing of needed transactions. Also shown is the mainframe Listener/Director 109 communication interface which communicates with the mainframe\legacy programs 112 that interface with the Legacy Systems 113 to return the needed data. Legacy data sources 114, depending on the function, may come from a data warehouse\data mart 115 or Legacy Systems on the mainframe. There is a data access server 116, where the mainframe director can initiate a call to this service to return data from the SQL Server application data. Also shown are client-downloaded ActiveX controls 118, which are EXE for browser environment such as for formatting of forms called by HTML and other files 120, as well as Rich Text Format file 122 created on the server for download to the client machine through the browser.

There are also an EXE 124 which are stand alone EXE's that perform batch-like functionality. This program is scheduled by the SQL Server application data.

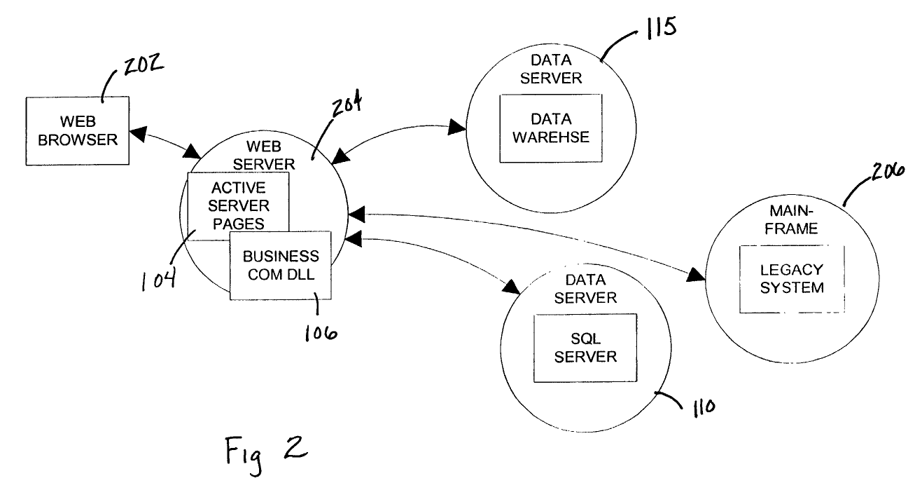

Referring to FIG. 2, a functional block diagram depicting a typical Business component DLL 106 and the interactions with other components in the network. The Business DLL represent logical objects or blocks of related data and functionality. For example, the “Customer” Business component represents the bank customer. This component presents all the data and functionality related to the bank customer. The data is presented to the interfacing layer, typically the Active Server Pages 104, as properties. These properties are presented as single elements or collections of repeating elements. Functionality related to the customer is represented as methods such as “save”. The “save” method gathers all data or customer properties and commits those pieces of data to the appropriate data store.

In most cases, the Business component is created and initialized with a call to the ‘Init’ method. The ‘Init’ method is given parameters by ASP or other calling objects to allow it to gather the objects' data and present it back to the requesting interface via properties. This provides an insulating layer between the presentation logic layer 126, refer to FIG. 1, and the data source layer 128. The presentation layer 126 does not have to be aware of the specific location and format of the data sources layer 128.

The Business components also enforce the business rules surrounding each function and data element. For instance, the New Checking component contains logic to verify that there is at least one customer related to the account before submitting. If this business rule is not fulfilled, the component will reject the request originating at the web browser with an appropriate error message. The Business DLL resides on the web server farm 204, along with the ASP 104. The web server farm 204 is centralized and can be accessed by various branch offices by utilizing the web browser. The web server is communicably linked via a TCP/IP interface to the Data Server Warehouse 115, the Application Data Server 110 and the mainframe system 206.

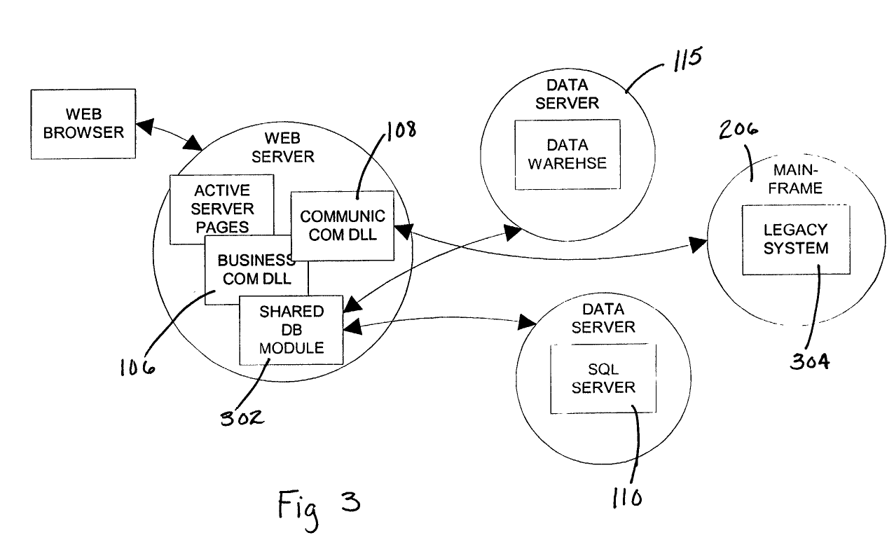

Referring to FIG. 3, a functional block diagram depicting the communication components and the interactions with other components in the network is shown.

The shared DB module 302 provides the functionality and logic to the Business DLL 106 for interacting with the various DB. Each Business component that requires DB connectivity includes this shared module in the compiled product. Centralizing this logic into the DB module provides consistent access methods using industry libraries adapted to access various types of DB's using SQL such as MICROSOFT ADODB or other adequately similar libraries. The logic contained within includes the initialization of appropriate libraries, establishment of a communication channel to the data source, standard error trapping and reporting, centralization of data access user identifiers and authentication data and proven, optimized logic for running queries, deleting rows and inserting data, updating and/or deleting data.

The Communication DLL 108, using object modeling techniques, provides the functionality and logic to the Business DLL for interacting with the mainframe 206 it's Legacy Systems 304. Like the shared DB module, the Communication DLL 108 centralizes the logic for establishing communication and managing the communication as well as providing methods for interrogating the return string and translating or parsing it.

Through an industry standard WINDOWS SOCKET (WinSock) library or adequately similar library, for providing interface between windows applications and TCP/IP, the DLL creates a TCP\IP communication channel with the appropriate Computer Information Control System (CICS) mainframe region. Once the communication handshaking is successful, the DLL transmits the passed in command string from the Business component and waits for a response. Once the mainframe 206 responds, the communication DLL notifies the Business component and provides methods for parsing the return string. The Business component will, in most cases, then commit that parsed data to the SQL Server 110 DB.

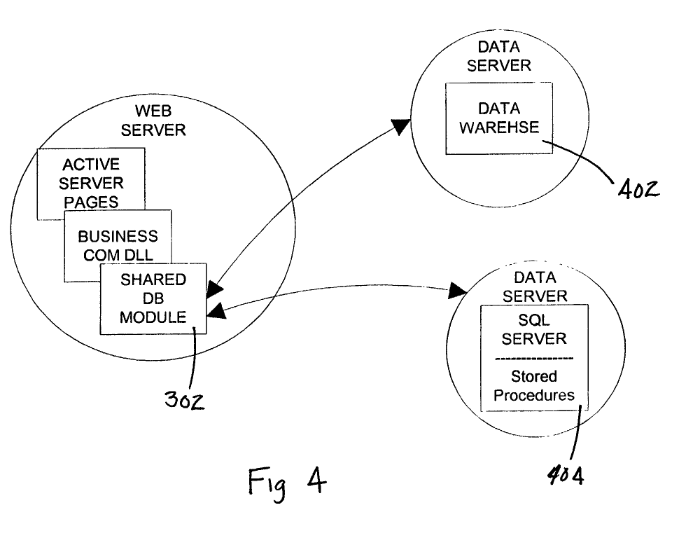

Referring to FIG. 4, a functional block diagram depicting Data Servers and the interactions with other components in the network is shown.

The shared DB module 302 provides the functionality and logic to the Business DLL 106 for interacting with the SQL Server DB and the Data Warehouse resources 402. The data on the SQL Server represents data that has been collected from the users or has been retrieved from the mainframe in order to provide a storage location to accommodate the application. The data on the Data Warehouse represents specific ATM transactions that are loaded daily for access by the application.

Most communication between the shared DB module and the SQL Server occurs using stored procedures 404. Stored procedures are precompiled collections of SQL statements stored under a name and processed as a unit. Stored procedures are stored within the DB and directly accessible by DB module; they can be executed with a call from the shared DB module. Stored procedures interact with the DB by returning data from the DB, updating data in the DB, creating data in the DB, or applying business rules as requested by the shared DB module.

All communication between the shared DB module and the Data Warehouse occurs using standard statements which are dynamically created in the Business DLL and then passed the shared DB module to be processed. The Data warehouse will then handle the request and return the appropriate response to the calling application module.

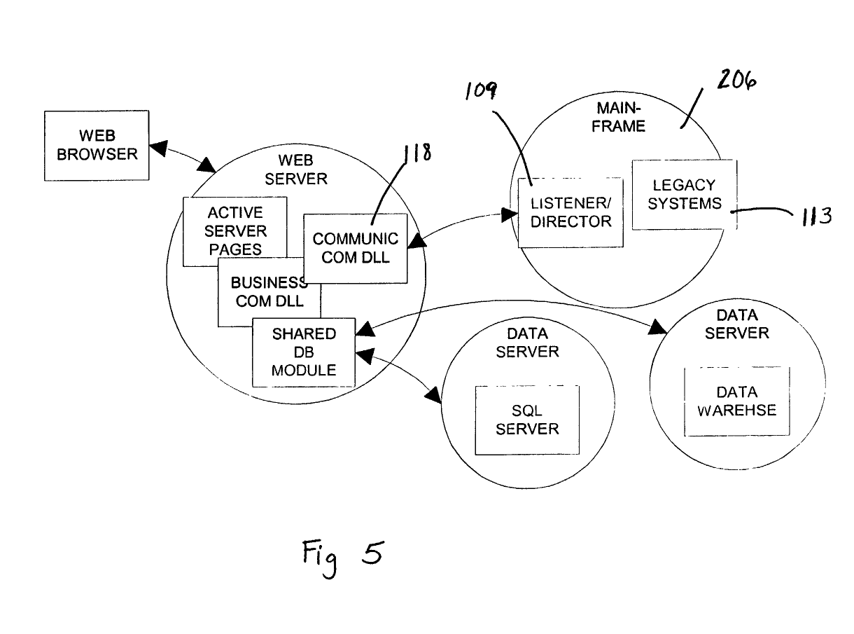

Referring to FIG. 5, there is a functional block diagram depicting the mainframe Listener/Director program and the interactions with other components in the network is shown.

The mainframe Listener/Director 109 monitors a given port on the mainframe 206 for network messages. When a message arrives, the mainframe listener accepts the message, parses the message and determines the action to take. Depending on the message, the listener will then direct the action required to another program that will interact with the appropriate Legacy System 304 on the mainframe and return the appropriate data.

Errors in communication or in processing are handled by the Listener\Director 109 and returned to the calling program - in this case the Communication DLL 108. In most cases, the mainframe listener\director will call a program to extract data from one or more Legacy Systems 113. The listener\director will then build the return message in the appropriate, specialized, delimited format required by the network Communication DLL.

The return string is a specialized, delimited string, in that it separates each data element with a delimiter, except when the singly occurring data needs to be separated from repeating data sets. In this case, multiple paired delimiters surround the repeating data sets like an open and closed bracket pair. The data within each delimiter pair are further separated by another delimiter.

For example, the process for opening a new account is a process that is similar for demand deposit, CD, IRA and plastic products. The download process for opening a new account is similar for demand deposit, CD, IRAs and plastic products. When a first-time user requests the application home page, several ActiveX controls and other related files will be downloaded. Among these are the TreeView interface control, associated bitmaps for the control, Masked Edit interface control, Remote FTP control, PrintForm control, print form files, a local printing engine and a download version file.

The Remote FTP ActiveX control is downloaded first and assists in the download of the bitmaps, forms and other files. The version file is used to store the latest download version number successfully installed on the client machine. Each new visit to the application home page will verify the download version number and download the new file(s) (commonly new print form files) as necessary.

The loan process involves more steps which are explained further below. The New Account process begins with the client PC 102, referring back to FIG. 1, requesting new account opening forms. The ASP returns the needed forms as Dynamic Hyper-Text Mark-up Language (DHTML) documents, or documents with dynamic content, to the client browser. Most forms are pre-filled with customer-related information and\or bank-related information through the use of the^{]} Business components 106. Some field level validation script is included in the forms at the client to reduce the number of server round trips for data validation rules. The field level validation script of the DHTML provides feedback and functionality to the user such as providing an indication that an entry error has occurred when entering data into one of the data entry fields.

Once sufficient customer data has been entered and saved, the user typically initiates the customer credit check process. This service function is the process involved in fulfilling service requests. This process is similar for most services offered such as: CHEX SYSTEMS credit check, stop payment place and removal, customer mailing address change. The service fulfillment process is much like the Customer and Account Inquiry process described later in this document. Once the user has gathered the necessary information to submit a service request, the user will initiate that process from the browser. The ASP 104 will call the necessary Business component 106 which initiates the service function through the data Communication component 108, which communicates with the mainframe listener which executes the appropriate mainframe transaction. In the case of a real time-time service function, the mainframe transaction executes on the Legacy System and returns the “success” indicator and/or the necessary service data. The data Communication component receives this data and saves it to the application data source, passes control back to the Business component and on to the ASP to present the results to the user. In some cases, such as the stop payment removal process, the service will be fulfilled by means of a generated email to the appropriate operational person. The data Communication component involved will generate an email file on the server for pickup and transmittal by a separate emailing service running on the server. Any failure to email the files are logged and notification is given to the support personnel.

The data saving process follows the path from client 102 ASP 104, to Business components 106, to data Communication components to insertion into the SQL Server application DB. The final step for the user is to submit the New Account application(s) to the destination system. As a part of that submission process the Business components 106 will determine if the data for submission is valid and complete. If so, the user will print the forms and submit the application data in one step.

The printing process can be accomplished in multiple ways. The simplest of these is the printing of an HTML document from the browser through script. The second way used is the sending of print commands through the PrintForm ActiveX control. This method will print to the Windows default printer, but allows for only the simplest of documents and formatting\layout methods. The third method involves creating an RTF file 122, referring again to FIG. 1, on the server and then returning to the client a link to this file. Upon clicking the link, the user's associated program (i.e.: MICROSOFT WORD) will start and load the RTF file for manual modification and printing. This method is utilized in the customer letter functionality, so as to allow customization of the letter. The format of the document is limited to the abilities of the Rich Text Format.

The final method also utilizes the PrintForm control but utilizes a different method of writing a data file to the client 102 and merging the data file with a preexisting print form file on the client. The form and the data file are merged through use of the local print engine previously downloaded. Most printing of account opening forms is handled through this means.

The submission to the mainframe during the New Account Process follows the path of ASP, to Business components, to data Communication component, to mainframe listener to mainframe transaction. The communication to the mainframe is simply a string indicating the intention to submit a customer session and a unique identifier or key for that session data. The mainframe will complete the communication by spawning a mainframe transaction to gather the session data and return an “OK - message received” response to the mainframe communication component. The result to the user will be a “Session submitted” message.

In an independent process, the spawned mainframe transaction will communicate down to the SQL application data via the NT data access component 116 that runs as a service on the data server. The mainframe transaction gathers information about the session using the unique session key. Through multiple SQL select statements, the mainframe transaction retrieves data about the number, status and type of cart items or products (such a loans, checking accounts, etc.) in the session being submitted. Further SQL statements are issued to gather the specific product data for each.

In most instances the data for account setup will be stored in a file that will be processed during the nightly batch processing cycle. In other cases, such as new customer and customer-account relationship data, the customer information system is updated real time. Therefor, data is available to other remotely located client computers. The final step in the process is for the mainframe transaction to issue an update to the application data store to indicate the submitted cart items are complete. Being marked complete indicates that the data has either been stored real time-time to the destination system or the data has been stored for inclusion in the nightly batch processing cycle.

The process for applying for a loan involves an additional step of credit approval or underwriting. This process is much like the two-phased submission process described above. When the user submits an application for underwriting, the ASP passes the data to the Business components, which use the communication components to transmit that data to the underwriting system on the mainframe. A return code is received by the web-side indicating the data was passed successfully.

At this point, the underwriting system will automatically score the application, which triggers a mainframe transaction to insert the score into the application data source. Within the underwriting system, the application appears in a queue awaiting a decision by an underwriter at a console. When the underwriter entering their decision, this triggers a mainframe transaction to again update the application data source with this information.

The browser user at the client PC will continue to inquire of the loan status until the decision has been made and can been seen by means of the updated application data source. The loan status is updated so that the closing and submission process can continue. This submission process follows a similar process as described above for other account types.

The process of inquiring on existing customer and account data through the intranet network begins with the web browser on the client PC initiating a request for a customer or account. The search Universal Resource Locator (URL) is passed via TCP\IP to the web application server. The URL is made up of an ASP page followed by the search criteria entered on the web form. Some field level validation is handled at the client to reduce the number of server round trips for data validation rules. The ASP accepts the search criteria and calls the appropriate Business component DLL method with the search criteria. The Business component validates the data passed to it and processes any applicable business rules.

In the case that the data exists on a Legacy System, the data access component is called to check the SQL Server application data via stored procedures or dynamically built SQL statements. If the customer or account has already been retrieved from the mainframe, the data will have been stored in the SQL DB, thereby eliminating the need to query mainframe. If the data is NOT found in the SQL Server DB, a mainframe transaction string is created and passed to the mainframe communication component.

The mainframe communication component receives the transaction string, establishes a WinSock conversation with the mainframe listener and passes the transaction. This component (the mainframe communication component) is responsible for creating, maintaining and breaking down the communication to the mainframe.

The mainframe listener receives the transaction string and parses it to determine where it needs to be directed. The listener then executes the necessary mainframe transaction(s) against the legacy data.

On the return trip, the data string will be returned to the mainframe communication component and inserted into the SQL server application DB by the direction of the Business components. Control is returned to the Business component, which retrieves the data from the SQL server application DB and builds the necessary properties and\or collections to present the data to the ASP. The ASP formats the data as a DHTML document, which is returned to the client browser to complete the process.

In the case that the data exists on a data warehouse or data mart, the data access component retrieves the data from the warehouse or mart via stored procedures or dynamically executed SQL statements. Control is returned to the Business component and properties and\or collections are populated. The ASP uses the business object to build the DHTML document as mentioned above.

There are various support measures taken in the platform system for error logging, web traffic logging, NightRun process and email notification. The system has been designed to handle the various errors. These errors include run-time errors, communication errors, and data errors. If an error is encountered with the request from the client PC via the ASP the error is logged. The error is either detected by the Business components or in the data components. The error is logged to the SQL Server application DB via the data components. The following information is logged: error number, error type, error description, error location, the user whose request caused the error and the date/time the error occurred. This information is then emailed to the appropriate support personnel as discussed later in this document. The present invention allows error messaging to be readily customized for improved user interface.

MICROSOFT IIS uses log files to track information about events that occur when users access IIS Web sites and applications. Information such as the number of visitors to the site or application, the number of bytes sent and received, and the referring page are types of information that can be found in the logs. These logs are then used to discern trends and patterns of the Web site and application.

NightRun is an executable, referring back to FIG. 1, that resides on the SQL Server application DB that is scheduled to run at the end of each business day. If during the account setup process the mainframe listener or mainframe transaction is not available, the data for this account is saved until NightRun executes and attempts to submit this information to the mainframe again. The path follows from the SQL Server application to NightRun then to data\communication component to mainframe listener to mainframe transaction. The communication to the mainframe is simply a string indicating the intention to submit a customer session (a grouping of like information relating to at least one customer interaction where information can be later retrieved) and a unique identifier or key for that session data. The mainframe will complete the communication by spawning a mainframe transaction to gather the session data and return an “OK—message received” response to the mainframe communication component. In an independent process, the spawned mainframe transaction will communicate down to the SQL application data via the NT data access component that runs as a service on the data server. The mainframe transaction gathers information about the session using the unique session key. Through multiple SQL select statements, the mainframe transaction retrieves data about the number, status and type of cart items in the session being submitted. Further SQL statements are issued to gather the specific cart item data for each. If this submission is not successful then NightRun will log this information to be Emailed to the proper personnel as discussed later in this document. The account information will reside in the SQL Server application DB until it has been successfully been transmitted to mainframe transaction.

Email can be generated by errors being logged to the SQL Server application DB, NightRun failure reports, or from the application itself. The application uses Simple Mail Transport Protocol (SMTP). This is a standard for Internet Email delivery. The Emails are directed to the correct support area based on the type of Email. NightRun produces an Email each business day to give a status from the process . Error logging produces Email as the errors occur, so that the proper support personnel can address these issues. The application itself will also Email to the appropriate support area the information necessary to handle requests for changes to customer/account addresses.

The system also provides various administrative tools and all Administrative Tool functionality follows a similar process. The Administrative Tools are to be used by the system administrator to setup users and products as its main features. The process begins with the client PC requesting an Admin Tool forms. The ASP returns the needed forms as DHTML documents to the client browser. Field level validation script is included in the forms at the client to reduce the number of server round trips for data validation rules.

Once sufficient data has been entered and saved, the data saving process follows the path from client to ASP to Business components to data components to insertion into the SQL Server application DB. The Administrative Tool features include Add/Edit User Information; Add/Edit Group Profile Information; Add/Edit Product Information; Maintenance User Customer Sessions; Maintenance Product Rates; and View Admin Tool Tracking Information.

In addition, the system provides a process for tracking/logging user actions called events. This process is similar for tracking/logging the following events: user login, viewing existing account information, performing customer services actions (customer/account level address changes and stop/remove pays), setting up new accounts and Admin Tool administration actions. The process begins with the client PC logging in and requesting customer level information, performing customer service actions, setting up new accounts or Admin Tool Administration events. The ASP initiate a request to the Business components to log the event information. Each event that is being logged has multiple unique attributes. The following is an example of the attributes that would be logged for a new deposit account being setup: employee number, employee location, account type, account number, bank number and opening deposit amount.

The Business component validates the data passed to it and processes any applicable business rules. The data access layer is called to access the SQL Server application data via stored procedures.

The SQL Server application data is maintained for the current business day and then the data is archived.

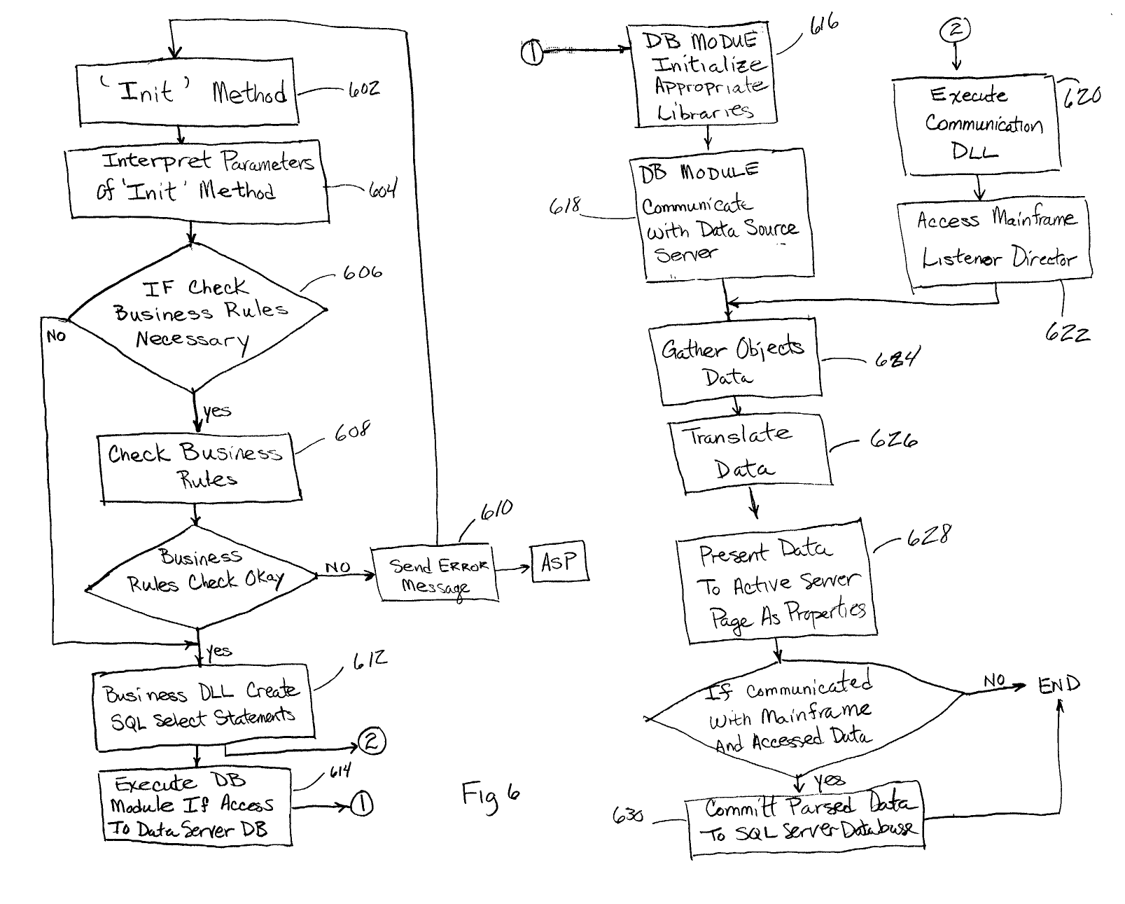

Referring to FIG. 6, a flow diagram is shown which is representative of a typical communication flow through the Business component DLL. The communication flow is typically initiated by an “Init” method from the ASP function as represented by functional block 602. The “Init” method parameters are interpreted 604. In many cases, depending on the parameters, there are specific Business rules which must be checked. A decision is made to determine if it is necessary to check the Business rules 606, and if there are Business rules to be checked, they are verified 608. If the Business rules do not check okay, then an error message 610 is sent back to the ASP. Once all the Business rules have been verified, the Business component DLL will create SQL statements 612. Depending on the request, the Business DLL may execute the DB module 614 if access to the data server DB is required. The DB module will initialize 616, the appropriate libraries and then the DB module will communicate 618 with the data source server. An alternative communication flow is the Business component will execute the communication DLL 620 and the communication DLL will access the mainframe listener director 622. Once a communication has been established and the data requests have been made, the Business component DLL will gather the objects data 624 and then translate the data 626. The Business component DLL will then present the data to ASP as properties 628. If communication with the mainframe was established and data was accessed from the Legacy Data Systems, then the parsed data is committed to the SQL server DB 630.

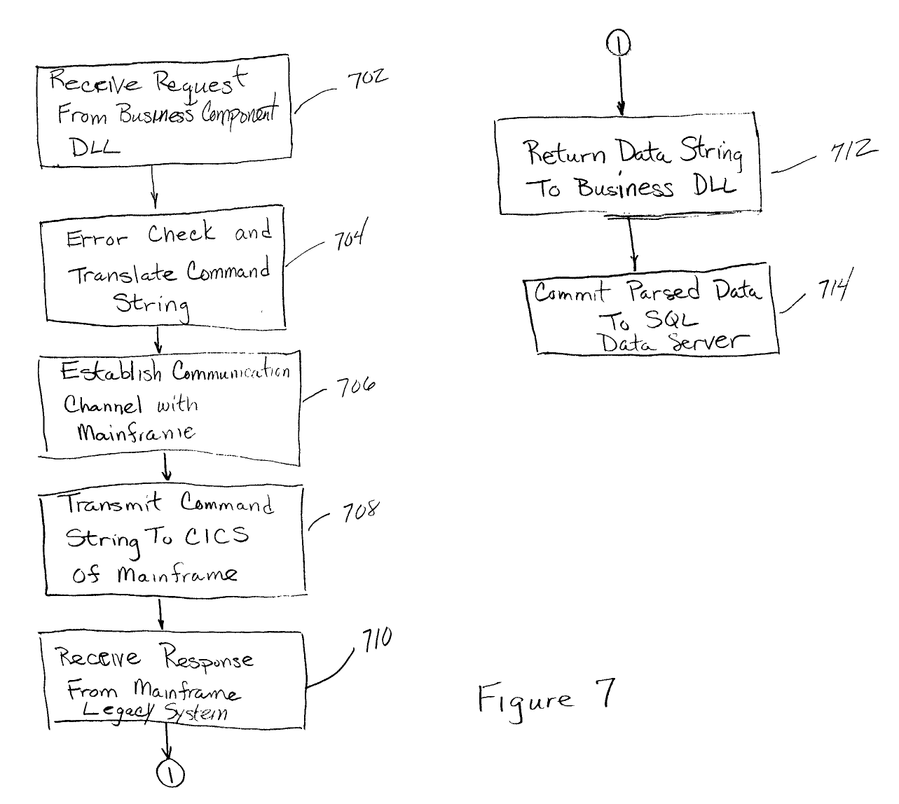

Referring to FIG. 7, a flow diagram is shown which is representative of the communication flow as seen as the mainframe interface. A request is received from the Business component DLL through the communication component DLL as represented by functional block 702. The communication component DLL performs an error check and translates the request into a command string 704. The communication component DLL establishes communication 706 with the mainframe and transmits a command string to the CICS of the mainframe as represented by functional block 708. Once the mainframe has serviced the request, a response is received from the mainframe Legacy Systems as represented by functional block 710. A return data string is transmitted back to the Business component DLL through the communication component DLL as seen by functional block 712. The data that was accessed from the Legacy DB from the mainframe is then committed as parsed data to the SQL server as seen by functional block 714.

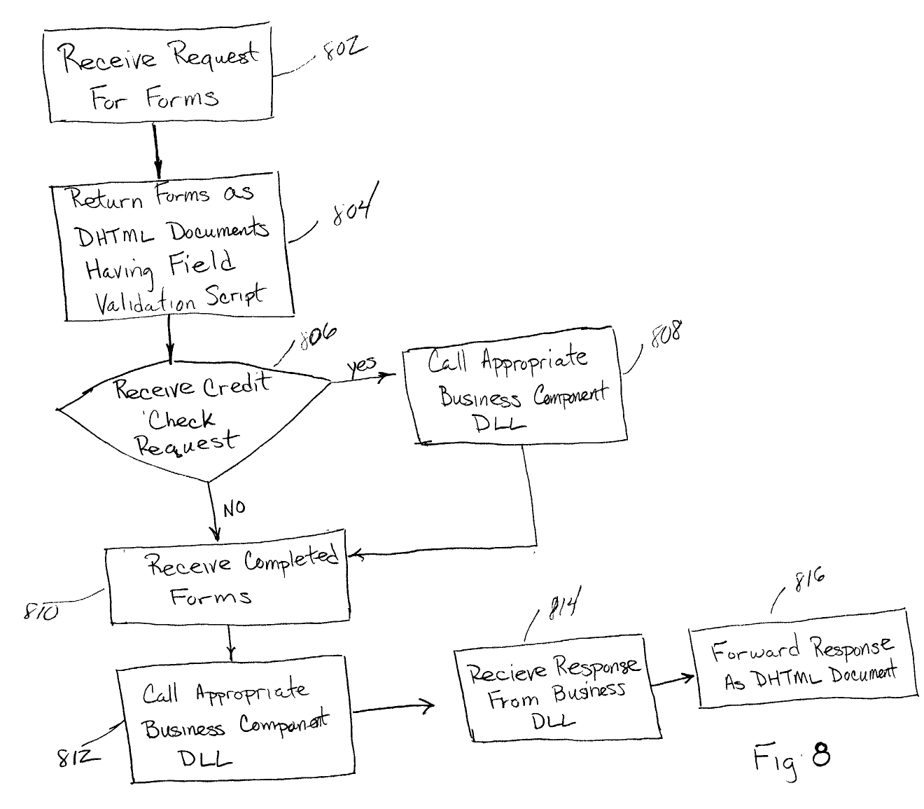

Referring to FIG. 8, a functional flow diagram is shown which is a typical communication flow through the ASP function. The ASP function receives a request for forms from the client computer as represented by functional block 802. The ASP function in response returns the requested form as a DHTML document having a field validation script as seen by functional block 804. In many instances a credit check is required, for example, in the case of a loan, therefore a credit check request is received from the client computer 806 and if a credit check is received, the ASP function will call the appropriate Business component DLL as seen by functional block 808. The user will input data into the data entry fields of the form as seen at the client computer and those inputs are transmitted using the browser of the client computer and thereby received as completed forms by the ASP function as represented by functional block 810. The ASP function will then call the appropriate Business component DLL 812. Once the Business component DLL has communicated with the appropriate data server and/or Mainframe Legacy System, the ASP receives a response from the Business component DLL 814. The response is forwarded as a DHTML document as represented by functional block 816 to the client computer.

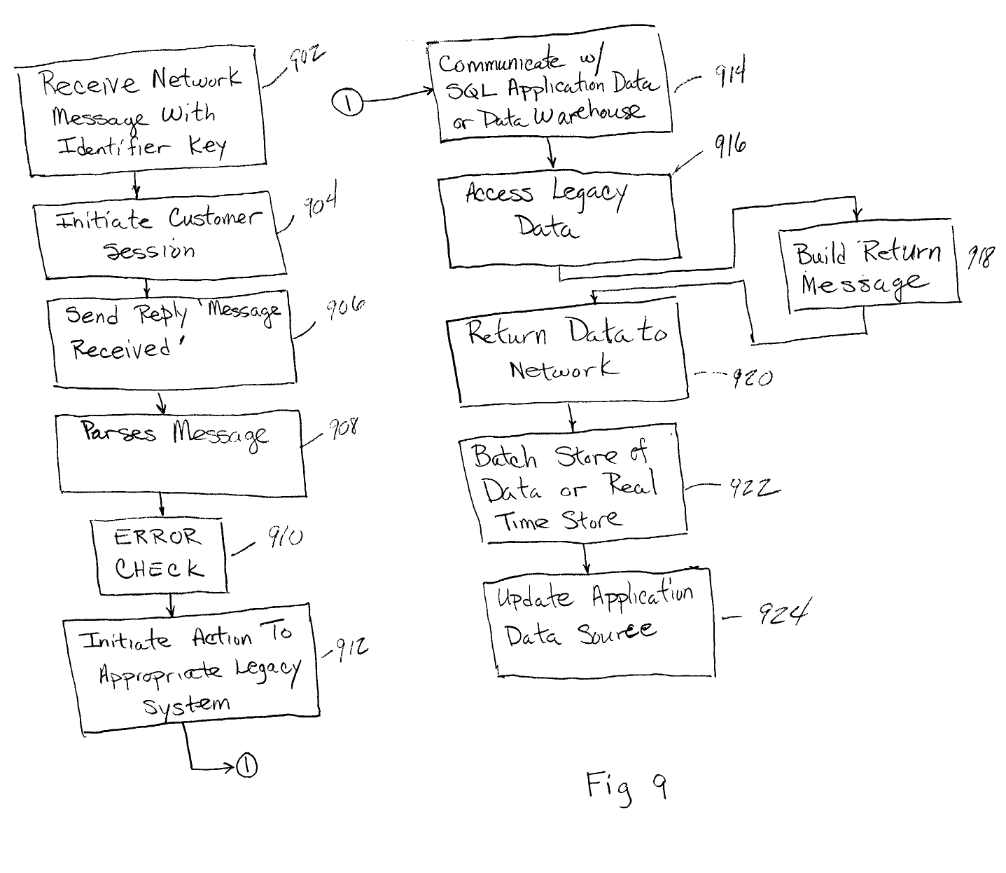

Referring to FIG. 9, a functional flow diagram that is representative of the typical flow scene at the mainframe listener/director function. The mainframe listener/director function receives a network message with an identifier key as represented by functional block 902. The mainframe listener/director interface initiates a customer session as seen by functional block 904 and then sends a reply message indicating that the message and identifier key was received properly from the network as represented by functional block 906. The mainframe listener/director function parses the message and performs an error check as represented by functional blocks 908 and 910, respectively. The mainframe listener/director interface then initiates an action to the appropriate Legacy System and initiates communication with the appropriate SQL application data server or data warehouse as needed, as represented by functional blocks 912 and 914, respectively. The Mainframe Legacy data is accessed as needed as represented by functional block 916 and once the appropriate data has been accessed, the Mainframe Legacy System transmits the data back to the mainframe listener/director which in turn bills a return message as seen by functional block 918. The return data is sent back to the network as seen by functional block 920 and a batch store of data or real time store of data is accomplished and the application data source servers are updated appropriately as represented by functional blocks 922 and 924, respectively.

The various web browser-based network examples shown above illustrate how an intranet environment can be utilized to solve many issues. A user of the present invention may choose any of the above net work embodiments, or an equivalent thereof, depending upon the desired application. In this regard, it is recognized that various forms of the subject web browser-based invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A web browser intranet based TCP/IP network for servicing various clients at remote sites comprising:
at least one remote client computer having a web browser application for viewing data from and inputting data into an ASP function; and
a centralized web server farm communicably linked over a TCP/IP network to said client computer and operable to provide and service the ASP, and said web server farm operable to access through DLLs over the TCP/IP network central data servers and existing mainframe Financial Institution Legacy Systems for servicing client requests through the DHTML ASP.

2. The web browser intranet based TCP/IP network as recited in claim 1 where said centralized web server farm is communicably linked to the Mainframe Legacy Systems through a Mainframe Director/Listener adapted translate communications and generate command strings between the TCP/IP network and the existing Mainframe Legacy Systems.

3. The web browser intranet; based TCP/IP network as recited in claim 1 said DLLs comprising a Business component DLL having a DB module for communicating to the central data servers and a communication DLL for communicating with the Mainframe Legacy Systems.

4. A method for networking at least one client computer using a web browser intranet based TCP/IP network comprising the steps of:
requesting service for a customer product from a remote client computer having a web browser application communicably linked to an ASP function residing on a centralized web server farm;
inputting data to the ASP function; and
servicing the request using DHTML from the ASP where the web server farm is communicably linked to said client computer and where said server farm accesses through DLLs over a TCP/IP network central data servers and existing mainframe Financial Institution Legacy Systems.

5. The method for networking at least one client computer using a web browser as recited in claim 4 where servicing is where the mainframe is accessed through a mainframe director/listener adapted to translate communications and generate command strings between the TCP/IP network and the existing Mainframe Legacy Systems.

6. The method for networking as recited in claim 4 where servicing is where the mainframe is accessed through DLLs comprising a Business component DLL having a DB module for communicating to the central data servers and a communication DLL for communicating with the Mainframe Legacy Systems.

7. An electronically programmable and computer readable medium having executable instructions for servicing web browser based client requests performing steps comprising:
inputting from a client computer having a web browser application requests for forms to the ASP function over a TCP/IP network;
outputting back to client computer requested forms as DHTML documents over the TCP/IP network;
inputting data entered into forms at the client computer to the ASP;
calling necessary Business component with the ASP;
initiating with the Business component service through a communication component;
outputting requests through communication component over the TCP/IP network to an appropriate centralized data server and to an existing Financial Institution Mainframe Legacy System.

8. The electronically programmable and computer readable medium as recited in claim 7 where initiating service through a communication component is initiating service through a DB module for outputting requests to the centralized data server and through a communication DLL for outputting requests to the existing Mainframe Legacy System.

9. The electronically programmable and computer readable medium as recited in claim 8 where the communication DLL outputting of requests is outputting to the mainframe listener/director of the Mainframe Legacy System.

10. A centralized server farm having an ASP function residing thereon for servicing a client computer in a web browser based TCP/IP network comprising:
an ASP function residing on a centralized server farm;
said ASP function operable to input requests for forms from a client computer over a TCP/IP network and output requested forms as DHTML documents over the TCP/IP network to a web browser interface of the client computer; and
said ASP function further operable to input data in the form of inputs to the DHTML document from the client computer and said ASP function operable to service the client computer responsive to the data inputs by being communicably linkable over the TCP/IP network to Data Servers and to an existing Mainframe Legacy System through a Business component DLL.

11. The centralized server farm having an ASP function residing thereon for servicing a client computer as recited in claim 10, where said ASP function is communicable linkable to the Data Servers through the Business component DLL and further through a DB module and communicably linkable to the Mainframe Legacy System through the Business component DLL and further through the Communication component DLL.

12. The centralized server farm having an ASP function residing thereon for servicing a client computer as recited in claim 11, where the ASP function is communicably linkable to the Mainframe Listenor/Director interface of the Mainframe Legacy System.

13. In a client computer system having a web browser application and having a graphical user interface including a display and a user interface, a method of providing an ASP generated DHTML document for servicing client requests comprising the steps of:
presenting on a graphical user interface a first DHTML document screen using a browser application for prompting a user request;
inputting through a user interface using the browser application a request in the form of data inputs to the DHTML document and transmitting the request through the browser application over a TCP/IP network to an ASP function on a centralized server farm which is communicably linked to centralized data servers and an existing financial institution Mainframe Legacy System for servicing user requests; and
servicing through the ASP the user request by acquiring information from the centralized data servers and the mainframe and by presenting a second DHTML document screen on the graphical user interface containing the information acquired.

14. The method as recited in claim 13, where presenting a first DHTML document is presenting a DHTML document having field level validation script.

15. The method as recited in claim 13, where presenting a first DHTML document is presenting a DHTML document having customer product information included as a field of data.

16. A method of communicating between a client computer having a web browser application and a Mainframe Legacy System comprising the steps of:
inputting service request from a client computer over a TCP/IP network to a centralized server farm;
outputting the requests from the server farm to centralized data servers and an existing financial institution Mainframe Legacy System and initiating the appropriate functions on the data servers and the mainframe for servicing the requests;
inputting to the server farm information responsive to the request from the data servers and the Mainframe Legacy Systems; and
outputting from the server farm DHTML documents to the client computer responsive to the service requests.

17. The method of communicating between a client computer and a mainframe as recited in claim 16, where outputting the requests from the server farm is outputting through the Business component DLL and through a DB module to the centralized Data Server and through the Business component DLL and through the Communication component DLL to the mainframe.

18. The method of communicating as recited in claim 17 where communication to the mainframe is communication to the Mainframe Listener/Director.

19. A method for networking one or more client computers to an existing financial institution Mainframe Legacy System using a web browser intranet based TCP/IP network comprising the steps of:
sending a request from a communication component DLL residing on a centralized server farm over a TCP/IP network to a communication interface of an existing financial institution Mainframe Legacy System responsive to a request from a client computer;
receiving a response from the communication interface of the Mainframe Legacy System to the communication component residing on the centralized server farm; and
forwarding the response as a DHTML document to the client computer.

20. The method as recited in claim 19, where forwarding the response is forwarding through an ASP function operable to generate a DHTML document.

21. The method as recited in claim 19, where the communication interface of the Mainframe is a Listener/Director interface operable to translate communications between the network and the mainframe and generate command strings.
